(19) United States
(12) Patent Application Publication
(10) Pub. No.: US 2009/0267771 A1
(43) Pub. Date: Oct. 29, 2009

(54) PASSIVELY TRANSFERRING RADIO FREQUENCY SIGNALS

(75) Inventors: Bruce B. Roesner, Durham, NC (US); Anthony J. Sabetti, Murphy, TX (US)

Correspondence Address: FISH & RICHARDSON P.C., P.O. BOX 1022, MINNEAPOLIS, MN, 55440-1022, US

(73) Assignee: SIRIT TECHNOLOGIES INC., Toronoto (CA)

(21) Appl. No.: 12/110,960

(22) Filed: Apr. 28, 2008

(51) Int. Cl. G08B 13/22

(52) U.S. Cl. 340/572.7

(57) ABSTRACT

The present disclosure includes a system and method for passively transferring radio frequency signals. In some implementations, a signal transfer element configured to passively transfer RF signals between a first region of a container and a second region of the container includes a first antenna, a second antenna and a coaxial transmission line. The first antenna is configured to wirelessly receive and transmit RF signals and passively transfer wirelessly received RF signals to a first end of a coaxial transmission line. The second antenna is configured to wirelessly receive and transmit RF signals and passively transfer wirelessly received RF signals to a second end of the coaxial transmission line. The coaxial transmission line is configured to passively transfer RF signals between the first antenna and the second antenna. A leg of the first antenna, a leg of the second antenna, and a center conductor of the coaxial transmission line are formed from a continuous conductor independent of physical connections.

### TECHNICAL FIELD

This invention relates to detecting radio frequency signals and, more particularly, to passively transferring radio frequency signals.

### BACKGROUND

In some cases, an RFID reader operates in a dense reader environment, i.e., an area with many readers sharing fewer channels than the number of readers. Each RFID reader works to scan its interrogation zone for transponders, reading them when they are found. Because the transponder uses radar cross section (RCS) modulation to backscatter information to the readers, the RFID communications link can be very asymmetric. The readers typically transmit around 1 watt, while only about 0.1 milliwatt or less gets reflected back from the transponder. After propagation losses from the transponder to the reader, the receive signal power at the reader can be 1 nanowatt for fully passive transponders, and as low as 1 picowatt for battery assisted transponders. At the same time, other nearby readers also transmit 1 watt, sometimes on the same channel or nearby channels. Although the transponder backscatter signal is, in some cases, separated from the readers' transmission on a sub-carrier, the problem of filtering out unwanted adjacent reader transmissions is very difficult.

### SUMMARY

The present disclosure includes a system and method for passively transferring radio frequency signals. In some implementations, a signal transfer element configured to passively transfer RF signals between a first region of a container and a second region of the container includes a first antenna, a second antenna and a coaxial transmission line. The first antenna is configured to wirelessly receive and transmit RF signals and passively transfer wirelessly received RF signals to a first end of a coaxial transmission line. The second antenna is configured to wirelessly receive and transmit RF signals and passively transfer wirelessly received RF signals to a second end of the coaxial transmission line. The coaxial transmission line is configured to passively transfer RF signals between the first antenna and the second antenna. A leg of the first antenna, a leg of the second antenna, and a center conductor of the coaxial transmission line are formed from a continuous conductor independent of physical connections.

### DESCRIPTION OF DRAWINGS

FIG. 1 is a block diagram of a transfer system for passively transferring radio frequency signals;

FIGS. 2A-C are block diagrams illustrating example energy transfer media;

FIG. 3 is a flow chart illustrating an example method for passively transferring radio-frequency signals;

FIGS. 4A-C are block diagrams illustrating example energy transfer media coupled to an RFID chip; and

FIG. 5 is a flow chart illustrating an example method for manufacturing energy transfer media.

Like reference symbols in the various drawings indicate like elements.

### DETAILED DESCRIPTION

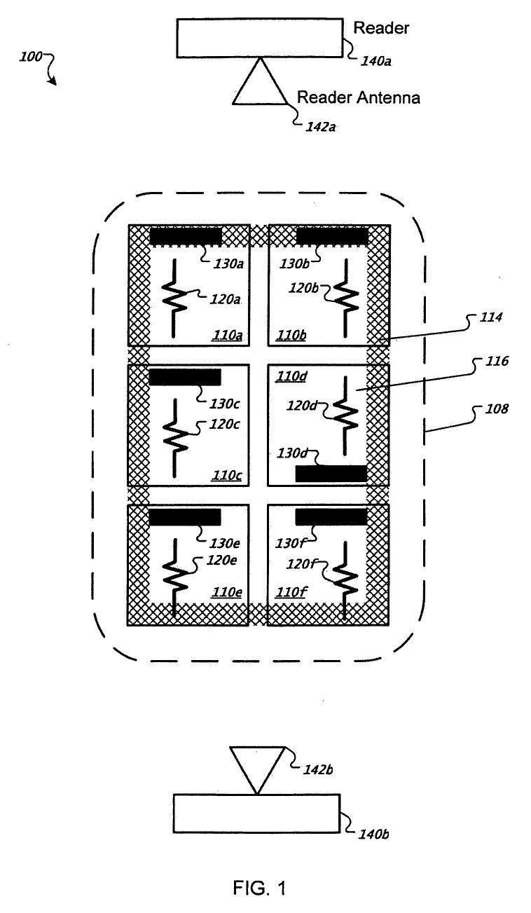

FIG. 1 is a top-view block diagram illustrating an example system 100 for transferring energy in accordance with some implementations of the present disclosure. For example, the system 100 may passively transfer radio frequency signals to obstructed Radio Frequency IDentifiers (RFIDs). In some implementations, the system 100 may include goods at least partially in containers. In managing such goods, the system 100 may wirelessly transmit RF signals to request information identifying these goods. In some cases, the RF signals may be attenuated by, for example, other containers, packaging, and/or other elements. For example, the system 100 may include containers with RFID tags that are stacked on palettes and are not located on the periphery. In this case, RF signals may be attenuated by other containers and/or material (e.g., water). In some implementations, the system 100 may passively transfer RF signals to tags otherwise obstructed. For example, the system 100 may include one or more transfer media that passively transfers RF signals between interior tags and the periphery of a group of containers. An energy transfer medium may include, for example, two passive antennas and two transmission lines for passive, wired signal transfer between the antennas. In some implementations, at least a portion on the antennas and the transmission line are formed using a continuous conductor. A continuous conductor may be a conductor configured to transmit incident RF signals from one location to a different location independent of physical connections. For example, physical connections may include soldered connections, mechanical connections, and/or other electrical connections. In some implementations, the system 100 can include energy-transfer media such that one leg of each antenna and the connecting transmission line are formed using a continuous conductor. For example, the system 100 may include a leg of each antenna and the connecting transmission line that are formed using the center conductor of a coaxial cable. In using continuous conductors to form the legs and transmission line, the system 100 may decrease, minimize, or otherwise reduce the cost associated with passive transmission media by reducing the number of connections and/or reduce attenuation of the RF signal being passively transferred.

At a high level, the system 100 can, in some implementations, include a group 108 including containers 110a-f, energy-transfer media 120a-f, RFID tags 130a-f, and readers 140a-b. Each container 110 includes an associated RFID tag 130 that wirelessly communicates with the readers 140. In some cases, the RFID tag 130 may reside in an interior region 116 of the group 108 not at or proximate the periphery 114. In this case, the energy-transfer medium 120 may passively transfer RF signals between interior RFID tags 130 and the readers 140. In other words, the transmission path between reader 140 and interior tags 130 may include both wired and wireless connections. For example, the group 108 may be a shipment of produce, and the containers 110 may be returnable plastic containers (RPCs) or crates, which are commonly used worldwide to transport produce. In some cases, produce is composed primarily of water, which may significantly attenuate RF signals and interfere with RFID tags 130c-130f in the interior region 116 from directly receiving RF signals. In this example, the energy transfer media 120 may transmit RF signals between the periphery 114 and the interior region 116 enabling communication between the RFID readers 140 and the RFID tags 130a-f. The system 100 may allow the produce shipment to be tracked and/or inventoried more easily, since each RPC can be identified by RFID while the shipment is stacked or grouped. While the examples discussed in the present disclosure relate to implementing RFID in stacked or grouped containers, the system 100 may be useful in a variety of other implementations. In some examples, the system 100 may be applied to the top surface of pallets to allow communication with boxes stacked on the pallet. In some examples, the system 100 may be applied to cardboard boxes by placing the antennas on different surfaces and bending the transmission line around the edges and/or corners.

Turning to a more detailed description of the elements, the group 108 may be any spatial arrangement, configuration and/or orientation of the containers 110. For example, the group 108 may include stacked containers 110 arrange or otherwise positioned on a palette for transportation. In some implementations, the group 108 may be a horizontal two-dimensional (2D) matrix (as illustrated), a vertical 2D matrix, a 3D matrix that extends vertically and horizontally, and/or a variety of other arrangements. The group 108 may be arranged regardless of the orientation and/or location of the tags 130. The containers 110 may be any article capable of holding, storing or otherwise at least partially enclosing one or more assets (e.g., produce, goods). For example, the containers 110 may be RPCs including produce immersed in water. In some implementations, each container 110 may include one or more tags 130 and/or energy-transfer media 120. In some examples, the tag 130 and/or the media 120 may be integrated into the container 110. In some examples, the tag 130 and/or the medium 120 can be affixed to the container 110. In some implementations, one or more of the containers 110 may not include a tag 130. In some implementations, the containers 110 may be of any shape or geometry that, in at least one spatial arrangement and/or orientation of the containers 110, facilitates communication between one or more of the following: tags 130 of adjacent containers 110, energy transfer media 120 of adjacent containers 110, and/or between tags 130 and energy transfer media 120 of adjacent containers. For example, the geometry of the containers 110 may include right angles (as illustrated), obtuse and/or angles, rounded corners and/or rounded sides, and a variety of other features. In some implementations, the containers 110 may be formed from or otherwise include one or more of the following: cardboard, paper, plastic, fibers, wood, and/or other materials. In some implementations, the geometry and/or material of the containers 110 may vary among the containers 110 in the group 108.

The energy transfer media 120 can include any software, hardware, and/or firmware configured to transfer radio frequency signals from one location to another. For example, the media 120 may include continuous material configured to passively transfer radio frequency signals between two locations. In some implementations, the media 120 may wirelessly receive an RF signal at one portion (e.g., first antenna) and re-emit the signal from a different portion of the media 120 (e.g., second antenna). The media 120 can, in some implementations, receive signals from or transmit signals to the RFID antennas 142, the RFID tags 130, and/or other energy-transfer media 120. For example, the RFID reader 140 may transmit an RF signal incident the periphery 114, and the media 120 may receive and re-transmit the signal to an interior tag 130. In some implementations, the media 120 can be at least a portion of a communication path between the RFID reader 140 and the RFID tag 130. For example, the media 120 may transfer RF signals between the periphery 114 and the interior 114 of the group 108. In doing so, the media 120 may establish communication paths to tags 130 otherwise unable to directly communicate with the reader 140.

In some implementations, the media 120 may include one or more of the following: conductive wires, antennas, coaxial transmission lines, strip lines, and/or any other features that passively transfer RF signals. For example, the energy transfer media 120 may include a leg from each antenna and a transmission line formed from a continuous conductor such as, for example, the center conductor of a coaxial cable. In this example, the media 120 may passively transfer RF signals between locations independent of physical connections along the transmission path. As mentioned previously, physical connections may include solder connections, mechanical connections, and/or other connections for connecting at least two elements of the media 120 (e.g., antenna legs and transmission line). In some implementations, the media 120 can include a first continuous conductor (e.g. center conductor) configured as a first leg of each antenna and a connecting transmission line and a second continuous conductor (e.g., shield) configured as a second leg of each antenna and a connecting transmission line formed from a shield of the coaxial cable. The energy transfer media 120 may be fabricated separately from and later attached or otherwise affixed to the container 110. The energy transfer media 120 may be integrated into at least a portion of the container 110. For example, the container 110 may be an RPC with an energy transfer medium 120 built into its structure. The energy transfer media 120 may include a variety of geometries, placements and/or orientations with respect to the tags 130 and/or containers 110. For example, the energy transfer media 120 may bend or curve around or through any interior or exterior feature of the container 110, such as corners, edges and/or sides. In some implementations, the media 120 includes directional antennas configured to, for example, increase transmission efficiency. In some implementations, the media 120 may be, for example, approximately six inches, 14 inches, and/or other lengths.

The RFID tags 130 can include any software, hardware, and/or firmware configured to backscatter RF signals. The tags 130 may operate without the use of an internal power supply. Rather, the tags 130 may transmit a reply to a received signal using power stored from the previously received RF signals independent of an internal power source. This mode of operation is typically referred to as backscattering. The tags 130 can, in some implementations, receive signals from or transmit signals to the RFID antennas 142, energy transfer media 120, and/or other RFID tags 130. In some implementations, the tags 130 can alternate between absorbing power from signals transmitted by the reader 140 and transmitting responses to the signals using at least a portion of the absorbed power. In passive tag operation, the tags 130 typically have a maximum allowable time to maintain at least a minimum DC voltage level. In some implementations, this time duration is determined by the amount of power available from an antenna of a tag 130 minus the power consumed by the tag 130 to charge the on-chip capacitance. The effective capacitance can, in some implementations, be configured to store sufficient power to support the internal DC voltage when the antenna power is disabled. The tag 130 may consume the stored power when information is either transmitted to the tag 130 or the tag 130 responds to the reader 140 (e.g., modulated signal on the antenna input). In transmitting responses, the tags 130 may include one or more of the following: an identification string, locally stored data, tag status, internal temperature, and/or others.

The RFID readers 140 can include any software, hardware, and/or firmware configured to transmit and receive RF signals. In general, the RFID reader 140 may transmit request for information within a certain geographic area, or interrogation zone, associated with the reader 140. The reader 140 may transmit the query in response to a request, automatically, in response to a threshold being satisfied (e.g., expiration of time), as well as others events. The interrogation zone may be based on one or more parameters such as transmission power, associated protocol, nearby impediments (e.g., objects, walls, buildings), as well as others. In general, the RFID reader 140 may include a controller, a transceiver coupled to the controller (not illustrated), and at least one RF antenna 142 coupled to the transceiver. In the illustrated example, the RF antenna 142 transmits commands generated by the controller through the transceiver and receives responses from RFID tags 130 and/or energy transfer media 120 in the associated interrogation zone. In certain cases such as tag-talks-first (TTF) systems, the reader 140 may not transmit commands but only RF energy. In some implementations, the controller can determine statistical data based, at least in part, on tag responses. The readers 140 often includes a power supply or may obtain power from a coupled source for powering included elements and transmitting signals. In some implementations, the reader 140 operates in one or more of frequency bands allotted for RF communication. For example, the Federal Communication Commission (FCC) have assigned 902-928 MHz and 2400-2483.5 MHz as frequency bands for certain RFID applications. In some implementations, the reader 140 may dynamically switch between different frequency bands. For example, the reader 140 may switch between European bands 860 to 870 MHz and Japanese frequency bands 952 MHz to 956 MHz.

In one aspect of operation, the reader 140 periodically transmits signals in the interrogation zone. In the event that the transmitted signal reaches an energy transfer medium 120, the energy transfer medium 120 passively transfer the incident RF signal along a continuous conductor to a different location retransmits and re-transmit the RF signal. The re-transmitted signal may then be received by another energy transfer medium 120, a tag 130, or a reader 140.

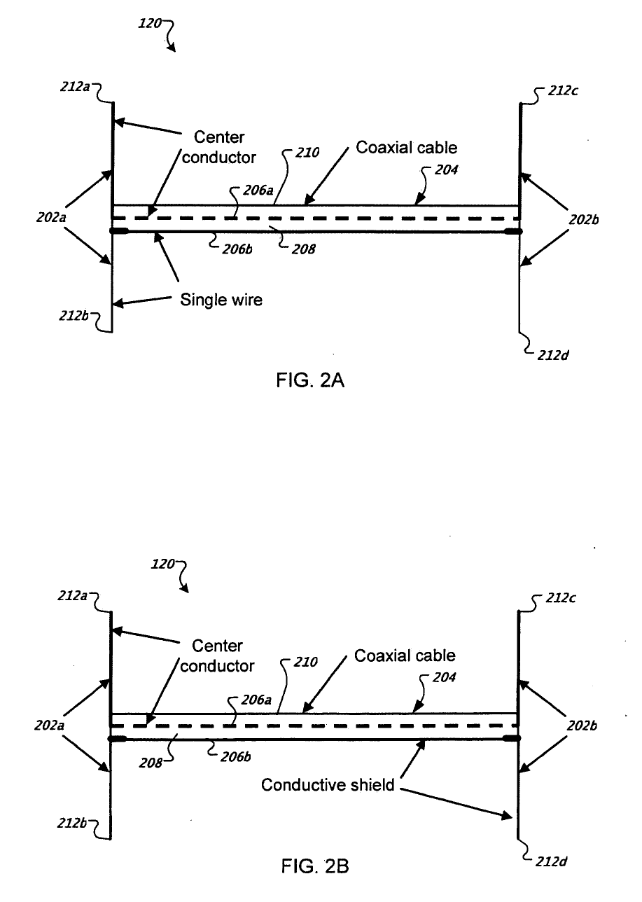

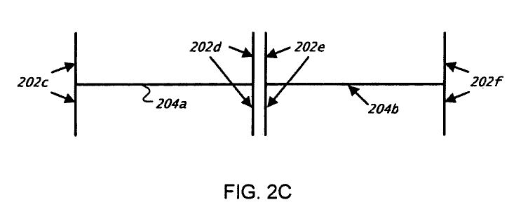

FIGS. 2A-C are diagrams illustrating example energy transfer media 120. The example energy transfer media 120 each include passive antennas 202a, 202b and a coaxial transmission line 204. The coaxial transmission line 204 may passively transfer signals between the antennas 202a and 202b. For example, the first antenna 202a may receive an RF signal (e.g., wirelessly from a reader 140), the coaxial transmission line 204 may transfer the signal to the second antenna 202b, and the second antenna 202b may retransmit the signal (e.g., for wireless communication with a tag 130). In the illustrated examples, the energy transfer media 120 are illustrated as substantially planar structures. However, in some implementations, the energy transfer media 120 are three-dimensional structures. For example, antenna 202a may be implemented at a different orientation, or the energy transfer medium 120 may bend or curve to accommodate the shape or contents of a container 110.

Turning to FIG. 2A, the coaxial transmission line 204 may be a coaxial cable that includes a center conductor 206 surrounded by an insulation layer 208. The insulation layer 208 may be surrounded by an outer conductor 210. A cross-sectional view of a cylindrical coaxial transmission line 204 is illustrated in FIGS. 2A and 2B. The coaxial transmission line 204 may be a low loss coaxial cable, which may improve signal transfer efficiency. In the illustrated implementation, the coaxial transmission line 204 is straight, but in other implementations the coaxial transmission line 204 can bend, turn, or curve, for example, accommodating features of a container 110. The coaxial transmission line 204 may connect two or more antennas 202 and passively transfer signals between or among the connected antennas 202.

The antennas 202a, 202b each include two conducting elements that typically referred to as antenna legs. The first antenna 202a includes the conducting elements 212a and 212b, and the second antenna 202b includes the conducting elements 212c and 212d. In the illustrated implementation, the conducting elements 212 are substantially straight, but in other implementations the conducting elements may bend, turn, or curve, for example, accommodating features of a container 110. In the illustrated implementation, the conducting elements 212 are substantially collinear and perpendicular to the coaxial transmission line 204, but in other implementations the conducting elements may be angled with respect to each other and/or with respect to the transmission line 204, for example, in a directional antenna. The conducting elements 212 may be implemented using metal wire, metal rods, printed conducting strips, or any other material suitable for wirelessly transmitting and receiving RF signals. The conducting elements 212 may be connected to an end of the coaxial transmission line 204.

In the illustrated implementation, the conducting elements 212a and 212c are conductively connected to each other by the inner conductor 206a, and the conducting elements 212b and 212d are conductively connected to each other by the outer conductor 206b. However, other configurations are also within the scope of the present disclosure. The conducting elements 212 may be either directly or indirectly connected to the coaxial transmission line 206. For example, the conducting elements 212a, 212c and the inner conductor 206a may be implemented as a single copper wire or continuous wire bundle. Similarly, the conducting elements 212b, 212d and the outer conductor 206b may be implemented as a single conductor. As another example, the conducting elements 212a and 212c and the inner conductor 206a may be two or three separate wires connected by solder. Similarly, the conducting elements 212b and 212d and the outer conductor 206b may be two or three separate elements connected, for example, by solder.

The energy transfer medium 120 of FIG. 2B may include the same elements as the energy transfer medium 120 of FIG. 2A. The energy transfer medium 120 of FIG. 2B additionally includes a conducting wire 206b connecting the conducting elements 212b and 212d. The conducting wire 206b is separated from the center conductor 206 by the insulation layer 208. In one aspect of operation, the antenna 202a wirelessly receives an RF signal transmitted from a reader 140. The received RF signal is transferred along the coaxial transmission line 204 to the antenna 202b. Then the antenna 202b wirelessly re-transmits the received RF signal. The re-transmitted RF signal may then be received, for example, by another antenna 202 or a tag 130.

The energy transfer medium 120 of FIG. 2C includes four antennas 202c, 202d, 202e, and 202f and two coaxial transmission lines 204a and 204b. The antennas 202c and 202d are coupled through the coaxial transmission line 204a, as in either of FIG. 2A or 2B. The antennas 202e and 202f are coupled through the coaxial transmission line 204b. The antennas 202d and 202e are wirelessly coupled, for example, due to their proximity and relative orientation.

In one aspect of operation, the antenna 202c wirelessly receives an RF signal, the coaxial transmission line 204a transfers the received signal to the antenna 202d, and the antenna 202d re-transmits the RF signal. The antenna 202e wirelessly receives the RF signal re-transmitted by the antenna 202d, the coaxial transmission line 204b transfers the received signal to the antenna 202f, and the antenna 202f re-transmits the RF signal. The RF signal re-transmitted by antenna 202f may be received, for example, by another energy transfer medium 120, by a tag 130, or by a reader 140.

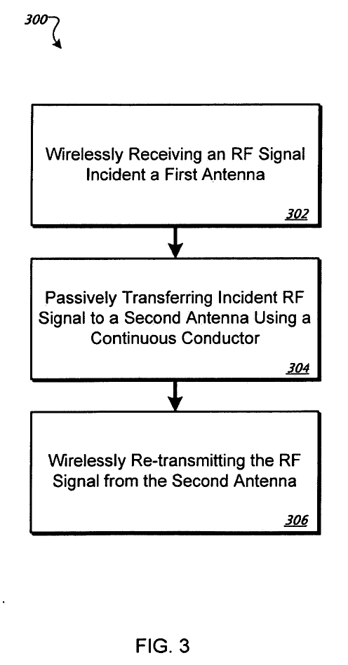

FIG. 3 is a flow chart illustrating an example method 300 for passively transferring RF signals between a first region of a container and a second region of the container. In particular, the example method 300 describes a technique for passively communicating RF signals using the energy transfer media 120 of FIGS. 2A-C. The RF signal may be received from the readers 140, the tags 130, or a different energy transfer medium 120. The method 300 is an example method for one aspect of operation of the system 100; a similar method, including some, all, additional, or different steps, consistent with the present disclosure, may be used to manage the system 100.

The method 300 begins at step 302, where an RF signal is wirelessly received using a first antenna. Next, at step 304, the incident RF signal is passively transferred to a second antenna using a continuous conductor. For example, a leg of the first antenna, a transmission path, and a leg of the second antenna may be continuous conductor independent of physical connections (e.g., soldered connections). Finally, at step 306, the RF signal is wirelessly re-transmitted using the second RF antenna. The re-transmitted RF signal may be received by a reader 140, a tags 130, or a different energy transfer medium 120.

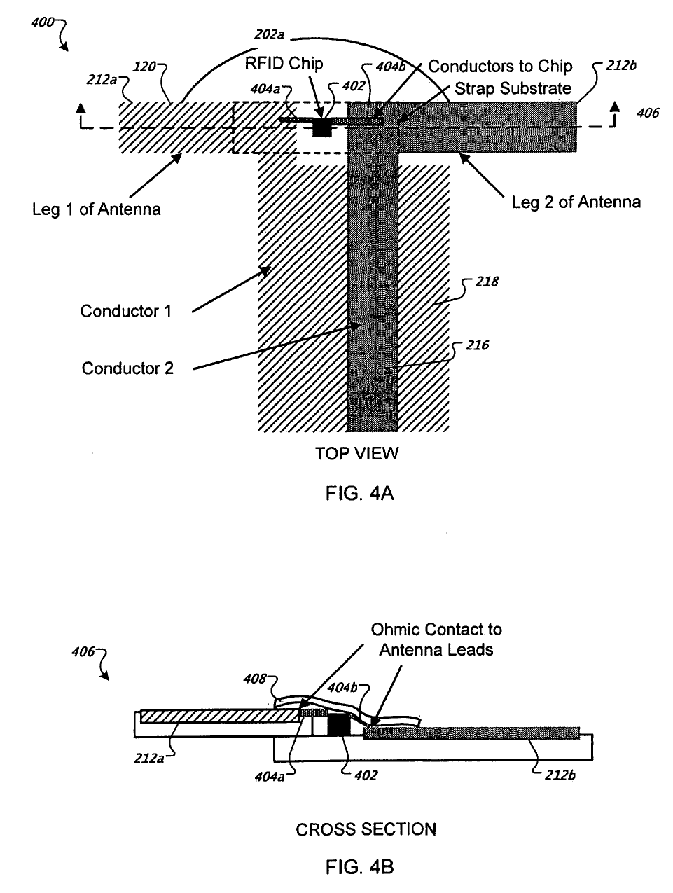

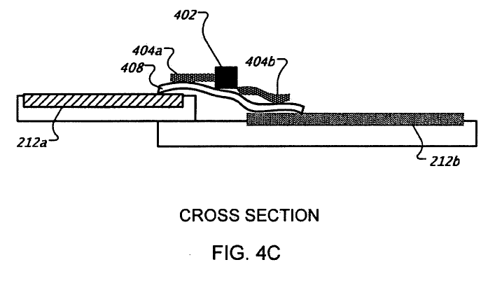

FIGS. 4A-C illustrate an example energy transfer media 120 coupled to an RFID chip 402 in accordance with some implementations of the present disclosure. For example, the RFID chip 402 may be directly connected to the energy transfer media 120. Referring to FIG. 4A, the antenna 202a is coupled to the RFID chip 402 such that RF signals are passively transferred directly to the RFID chip 402. In the illustrated implementation, the RFID chip 402 is at least coupled to the antenna 202a using the conductors 404a and 404b. The conductors 404a and 404b extend at least adjacent the RFID chip to at least adjacent a portion of the antenna legs 212a and 212b, respectively. The conductors 404a and 404b may be a metal alloy including, for example, copper, silver, and/or other metals. In some implementations, the conductors 404a and 404b are electrically connected to the RFID chip using, for example, solder, pressed indium, and/or other type of connection. In some implementations, the antennas legs 212a and 212b are capacitively coupled to the conductors 404a and 404b. The antenna 202a may passively transfer RF signals between the antenna legs 212 and the conductors 404.

Referring to FIG. 4B, the cross section 406 illustrates the RFID chip 402 directly connected to the antenna 202a. As mentioned above, one end of the conductor 404 is electrically connected to the RFID chip 402 and a different end is connected to the antenna legs 212. The conductors 404 may be connected using any suitable electrical connections such as, for example, a soldered connection, a mechanical connection, and/or other types. In this implementations, RF signals are passively transferred between legs 212 and the RFID chip 402 using a direct electrical connection. In some implementations, a layer 408 may protectively cover the RFID chip 402 and conductors 404.

Referring to FIG. 4C, the cross section 406 illustrates the RFID chip being capacitively coupled to the antenna 202. In the illustrated implementation, the conductors 404 are spatially separated from the conductors 404 by a layer 408 such that the arrangement of the conductors 404, the layer 408, and the antenna legs 214 substantially form a capacitor. In doing so, RF signals may passively transfer between the RFID chip 402 and the antenna 202a. The layer 408 may be any suitable material such as a dielectric. In some implementations, the layer 408 is 20 mils or less.

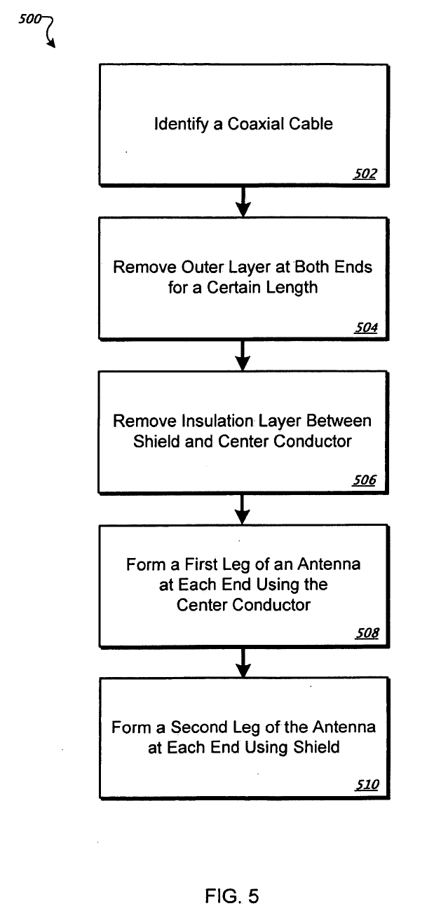

FIG. 5 is a flow chart illustrating an example method 500 for manufacturing energy transfer media in accordance with some implementations of the present disclosure. In particular, the example method 500 describes a technique for manufacturing media 120 of FIG. 2B using a coaxial cable. The method 500 is an example method for one aspect of manufacturing; a similar method, including some, all, additional, or different steps, consistent with the present disclosure, may be used to manufacture media 120.

The method 500 begins at step 502 where a certain length (e.g., 3 ft) of coaxial cable is identified. At step 504, the outer conductive shield layer of the coaxial cable is removed from both ends for a specified length. For example, a length of 3 in. may be removed from each end of the coaxial cable. In some implementations, the length of 2.3 in. may be used for 902 to 928 MHz, but the length may be longer (e.g., 10%) for European UHF band or 1 inch for 2.45 GHz. Next, at step 506, the insulating layer between the center conductor and the shield can be left in place or removed over the specified length. In some examples, the shield is cut along the specified length prior to removing the insulating layer. A first leg of an antenna is formed at each end using the center conductor at step 508. For example, the center conductor may be bent at substantially a right angle to form the first legs. At step 510, a second leg of the antenna at each end is formed using the shield.

A number of embodiments of the invention have been described. Nevertheless, it will be understood that various modifications may be made without departing from the spirit and scope of the invention. Accordingly, other embodiments are within the scope of the following claims.

What is claimed is:

1. A signal transfer element configured to passively transfer RF signals between a first region of a container and a second region of the container, comprising:
a first antenna configured to wirelessly receive and transmit RF signals and passively transfer wirelessly received RF signals to a first end of a coaxial transmission line;
a second antenna configured to wirelessly receive and transmit RF signals and passively transfer wirelessly received RF signals to a second end of the coaxial transmission line; and
the coaxial transmission line configured to passively transfer RF signals between the first antenna and the second antenna, wherein a leg of the first antenna, a leg of the second antenna, and a center conductor of the coaxial transmission line are formed from a continuous conductor independent of physical connections.

2. The signal transfer element of claim 1, the leg of the first antenna comprising a first leg of the first antenna, the leg of the second antenna comprising a first leg of the second antenna, wherein the coaxial transmission includes a shield coupled to a second leg of the first antenna and a second leg of the second antenna.

3. The signal transfer element of claim 2, wherein the second leg of the first antenna and the second leg of the second antenna are formed from the shield such that the second leg of the first antenna, the second leg of the second antenna and the shield form a continuous conductor independent of physical connections.

4. The signal transfer element of claim 2, wherein the first leg and the second leg of the first antenna are substantially collinear, the first and second leg of the second antenna are substantially collinear.

5. The signal transfer element of claim 1, wherein legs of the first antenna and legs of the second antenna are 2 inches (in.) or more.

6. The signal transfer element of claim 1, wherein the coaxial transmission line is substantially perpendicular to the first antenna and the second antenna.

7. The signal transfer element of claim 1, the first antenna comprising a directional antenna.

8. The signal transfer element of claim 1, the first antenna configured to receive and transmit RF signals in a first frequency range, the second antenna configured to receive and transmit RF signals in the first frequency range.

9. The signal transfer element of claim 1, the first and second antennas each configured to receive and transmit RF signals at one or more frequencies in either the frequency range from 125 KHz to 2.5 GHz.

10. The signal transfer element of claim 9, the coaxial transmission line configured to transfer RF signals at one or more frequencies in either the frequency range from 125 KHz to 2.5 GHz.

11. The signal transfer element of claim 1 integrated into the structure of the container.

12. The signal transfer element of claim 1 defining a substantially planar structure.

13. The signal transfer element of claim 1, the coaxial transmission line configured to bend around an edge of the container.

14. The signal transfer element of claim 1, the coaxial transmission line being greater than 2 inches long.

15. The signal transfer element of claim 1, the coaxial transmission comprising a low loss coaxial cable.

16. The signal transfer element of claim 1, further comprising:
an RFID chip electrically coupled with the first antenna; and
conductors connected to the RFID chip and at least spatially proximate the first antenna, wherein RF signals are passively transferred between the first antenna and the RFID chip using the conductors.

17. The signal transfer element of claim 16, wherein the conductors are connected to the first antenna.

18. The signal transfer element of claim 16, wherein the conductors are capacitively coupled to the first antenna.

19. The signal transfer element of claim 18, further comprising a dielectric layer selectively positioned between the first antenna and the conductors.

20. The signal transfer element of claim 19, wherein the dielectric layer is 20 mils or less.

21. The signal transfer element of claim 16, further comprising a protective layer adjacent the RFID chip and the conductors.

22. A method for passively communicating RF signals from a first region of a container to a second region of the container, comprising:
wirelessly receiving an RF signal incident a first antenna at least adjacent a first portion of the container;
passively transferring the incident RF signal from the first antenna to a second antenna in a second portion of the container using a coaxial transmission line; and
wirelessly re-transmitting the RF signal from the second antenna, wherein a leg of the first antenna, a leg of the second antenna, and a center conductor of the coaxial transmission line are formed from a continuous conductor independent of physical connections.

23. The method of claim 22, wherein the incident RF signal is transferred at an efficiency of at least 20%.

24. The method of claim 22, the leg of the first antenna comprising a first leg of the first antenna, the leg of the second antenna comprising a first leg of the second antenna, wherein the coaxial transmission includes a shield coupled to a second leg of the first antenna and a second leg of the second antenna.

25. The method of claim 22, the first and second antennas each configured to receive and transmit RF signals at one or more frequencies in either the frequency range from 125 KHz to 2.5 GHz.

26. The method of claim 22, the coaxial transmission line greater than 2 inches long.
